(19) United States
(12) Patent Application Publication
(10) Pub. No.: US 2024/0372274 A1
(43) Pub. Date: Nov. 7, 2024

(54) Electrical Connection Member, Electrical Connection Assembly and Charging Seat Assembly

(71) Applicants: Tyco Electronics (Suzhou) Ltd., Suzhou City (CN); Tyco Electronics Technology (SIP) Ltd., Suzhou (CN); Tyco Electronics (Shanghai) Co., Ltd., Shanghai (CN)

(72) Inventors: Jinshun (Jet) Wang, Suzhou (CN); Fangyue (Jason) Zhu, Suzhou (CN); Renyi (Ronny) Dou, Suzhou (CN); Ming Xu, Shanghai (CN)

(73) Assignees: Tyco Electronics (Suzhou) Ltd., Zuzhou (CN); Tyco Electronics Technology (SIP) Ltd., Suzhou (CN); Tyco Electronics (Shanghai) Co., Ltd., Shanghai (CN)

(21) Appl. No.: 18/653,231

(22) Filed: May 2, 2024

(30) Foreign Application Priority Data
May 4, 2023 (CN) 202310489200.7

(51) Int. Cl. H01R 4/2475; H01R 13/66; H01R 25/16

(52) U.S. Cl. CPC H01R 4/2475; H01R 13/665; H01R 25/161

(57) ABSTRACT

An electrical connection member includes an electric transmission body, a mating end connected to a first end of the electric transmission body, and a connecting end connected to a second end of the electric transmission body. The electrical connection member is an integral part. The mating end is a charging terminal for a charging seat and the connecting end is a connecting terminal for electrical connection with a busbar.

### CROSS-REFERENCE TO RELATED APPLICATION

This application claims the benefit of the filing date under 35 U.S.C. § 119 (a)-(d) of Chinese Patent Application No. 202310489200.7, filed on May 4, 2023.

### FIELD OF THE INVENTION

The present invention relates to an electrical connection member for connecting a charging gun to a battery pack, an electrical connection assembly comprising the electrical connection member and a charging seat assembly comprising the electrical connection assembly.

### BACKGROUND

In order to achieve electrical connection between a charging gun and a battery pack, it is usually necessary to provide a charging seat, a cable, and a connector. The charging seat includes a charging seat housing and a charging terminal arranged in the charging seat housing. The connector includes a connector housing and connection terminals arranged in the connector housing. One end of the cable is electrically connected to the charging terminal of the charging seat. The other end of the cable is electrically connected to the connection terminal of the connector.

It is therefore necessary to provide separate charging terminals for the charging seat and separate connection terminals for the connector, which will result in higher costs. Moreover, in the prior art, it is necessary to crimp or weld the end of the cable to the charging terminal of the charging seat or the connection terminal of the connector, which will reduce manufacturing efficiency. In addition, in the prior art, there is a significant resistance in the connection between the cable and the charging terminal or between the cable or the connecting terminal, which can cause a significant temperature rise in the product and seriously affect the safety of the charging equipment.

### SUMMARY

An electrical connection member includes an electric transmission body, a mating end connected to a first end of the electric transmission body, and a connecting end connected to a second end of the electric transmission body. The electrical connection member is an integral part. The mating end is a charging terminal for a charging seat and the connecting end is a connecting terminal for electrical connection with a busbar.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a charging seat assembly according to an exemplary embodiment of the present invention;

FIG. 2 shows a sectional perspective view of a charging seat assembly according to an exemplary embodiment of the present invention;

FIG. 3 shows an illustrative perspective view of an electrical connection assembly according to an exemplary embodiment of the present invention;

FIG. 4 shows a cross-sectional view of an electrical connection assembly according to an exemplary embodiment of the present invention;

FIG. 5 shows a cross-sectional view of an electrical connection assembly according to another exemplary embodiment of the present invention;

FIG. 6 shows an illustrative perspective view of an electrical connection member according to another exemplary embodiment of the present invention;

FIG. 7 shows a cross-sectional view of an electrical connection member according to another exemplary embodiment of the present invention; and

FIG. 8 shows a cross-sectional view of an electrical connection member according to another exemplary embodiment of the present invention.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

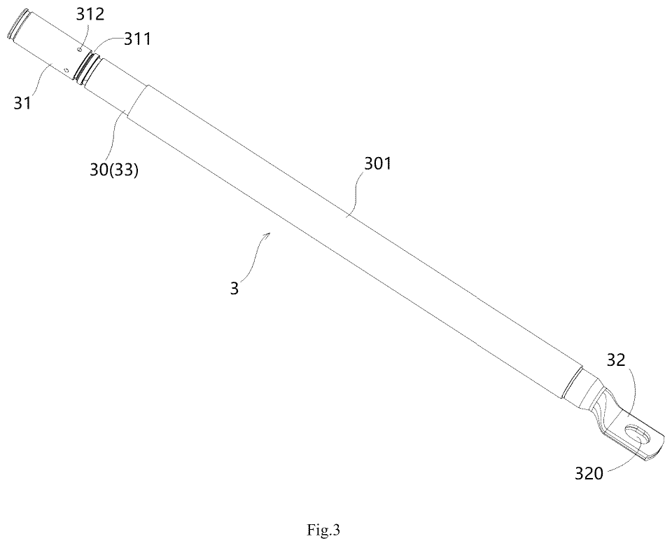

As shown in FIGS. 3 to 5, in an exemplary embodiment of the present invention, an electrical connection member 30 is disclosed. The electrical connection member 30 mainly includes an electrical transmission body 33, a mating end 31, and a connecting end 32. The mating end 31 is connected to one end of the electric transmission body 33. The connecting end 32 is connected to the other end of the electric transmission body 33. In the illustrated embodiment, the electrical connection member 30 is an integral piece. The mating end 31 of the electrical connection member 30 is used as the charging terminal of the charging seat 1, and the connecting end 32 of the electrical connection member 30 is used as the connecting terminal for electrical connection to a busbar (such as the busbar on the battery pack).

As shown in FIGS. 3 to 5, in the illustrated embodiments, the mating end 31 of the electrical connection member 30 is cylindrical, used for mating with a cylindrical mating terminal of a charging gun. The connecting end 32 of the electrical connection member 30 is flat and used for electrical connection with the busbar on the battery pack. However, please note that the shapes of the mating end 31 and the connecting end 32 of the present invention are not limited to the illustrated embodiments. For example, the mating end 31 of the electrical connection member 30 can be other suitable shapes. The connecting end 32 of the electrical connection member 30 can also be cylindrical or other suitable shapes.

As shown in FIG. 3, in the illustrated embodiments, a connection hole 320 is formed in the connecting end 32 of the electrical connection member 30 that allows a bolt to pass through, so that the connecting end 32 can be fastened to the busbar of the battery pack through the bolt.

As shown in FIGS. 3 to 5, in the illustrated embodiments, the electrical connection member 30 is an integral piece made of a hollow tubular piece, and one end of the tubular piece is processed into the mating end 31. For example, one end of the tubular piece can be processed into the mating end 31 through a stamping process. The other end of the tubular piece is processed into the connecting end 32, for example, the other end of the tubular piece can be processed into the connecting end 32 through a stamping process.

As shown in FIGS. 3 to 5, in the illustrated embodiments, the middle part of the tubular piece forms the electric transmission body 33, and the middle part of the tubular piece is not processed, resulting in the electric transmission body 33 being in a hollow tubular shape.

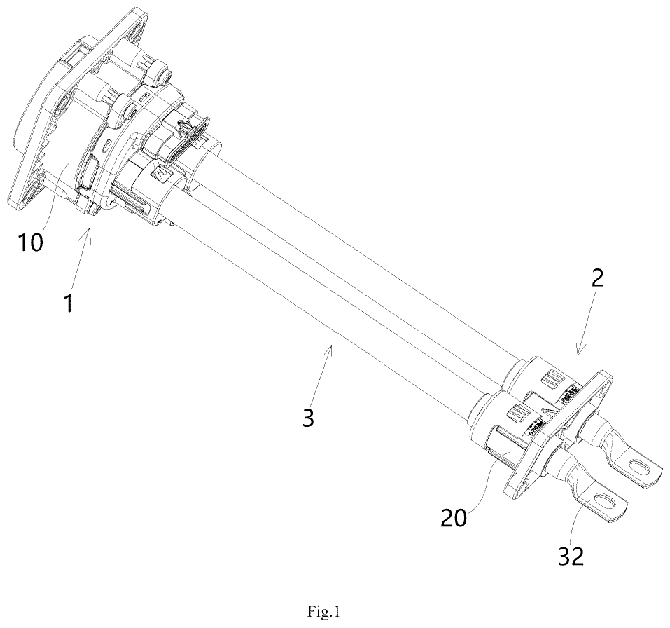

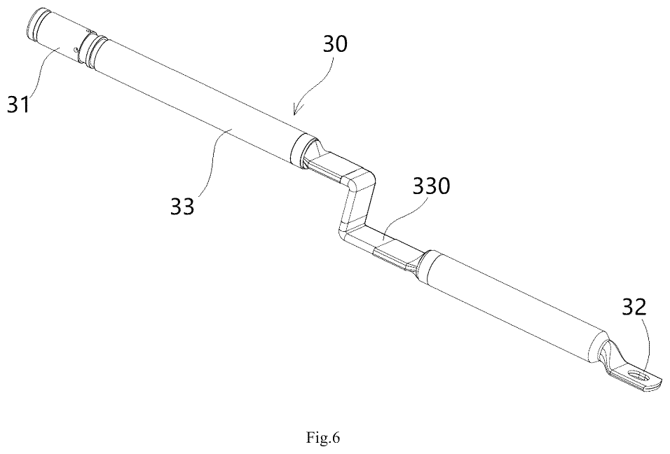

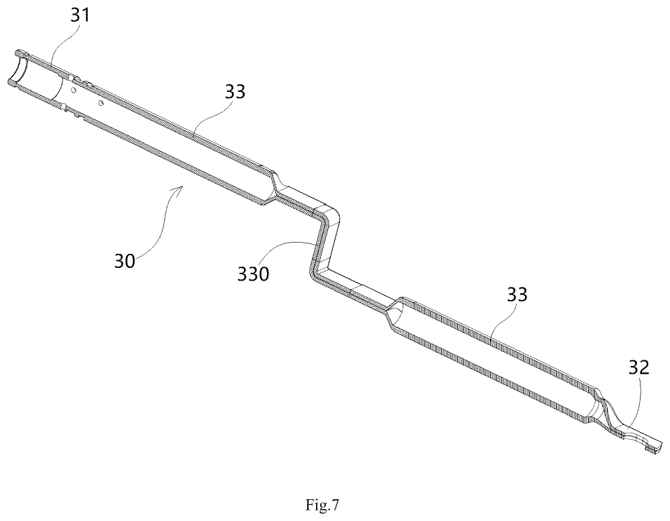

The electrical connection member 30 of the present invention is not limited to the embodiments shown in FIGS. 1 to 5. For example, FIG. 6 shows an illustrative perspective view of the electrical connection member 30 according to another exemplary embodiment of the present invention. FIG. 7 shows a cross-sectional view of the electrical connection member 30 according to another exemplary embodiment of the present invention.

As shown in FIGS. 6 and 7, in another exemplary embodiment of the present invention, the middle part of the aforementioned tubular piece constitutes the electric transmission body 33, and at least a portion of the middle part of the tubular piece is flattened and bent, so that the electric transmission body 33 has a flat bent portion 330. In this embodiment, by flattening a portion of the tubular piece, a smaller bending radius can be achieved, which can reduce space requirements and make it easier for the compact arrangement of the electrical connection member 30.

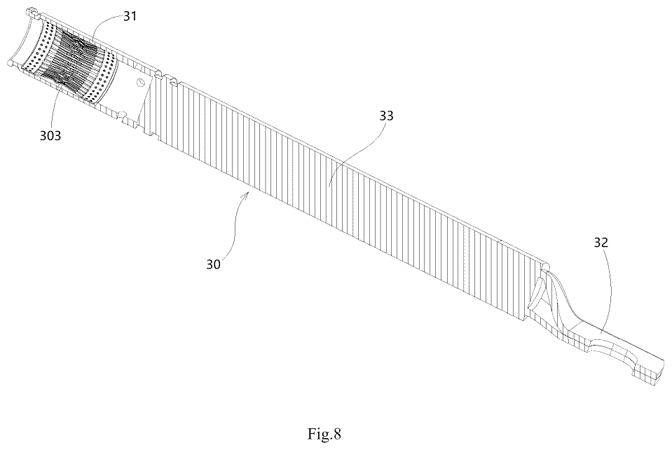

In the embodiments shown in FIGS. 3 to 7, the electrical connection member 30 is made of a hollow tubular piece. However, the electrical connection member 30 of the present invention is not limited to the embodiments shown in FIGS. 3 to 7. For example, FIG. 8 shows a cross-sectional view of the electrical connection member 30 according to another exemplary embodiment of the present invention.

As shown in FIG. 8, in the illustrated embodiment, the electrical connection member 30 is an integral piece made of a solid rod-shaped component. One end of the rod-shaped component is processed into a cylindrical mating end 31, which can be machined, cold-forged, or stamped, for example. The other end of the rod-shaped component is processed into a flat connecting end 32, which can be machined, cold-forged, or stamped, for example. As shown in FIG. 8, in the illustrated embodiment, the other end of the rod-shaped component is first processed into a hollow cylindrical shape, and then pressed into a flat shape. In this way, a flat connecting end 32 can be obtained.

As shown in FIGS. 1, 3, and 5, in another exemplary embodiment of the present invention, an electrical connection assembly 3 is also disclosed. The electrical connection assembly 3 includes the aforementioned electrical connection member 30 and the elastic terminal 303. The clastic terminal 303 is inserted into the inner cavity of the mating end 31 of the electrical connection member 30. The elastic terminal 303 is used to make electrical contact with the mating terminal of the charging gun inserted into the mating end 31, in order to electrically connect the mating terminal to the mating end 31.

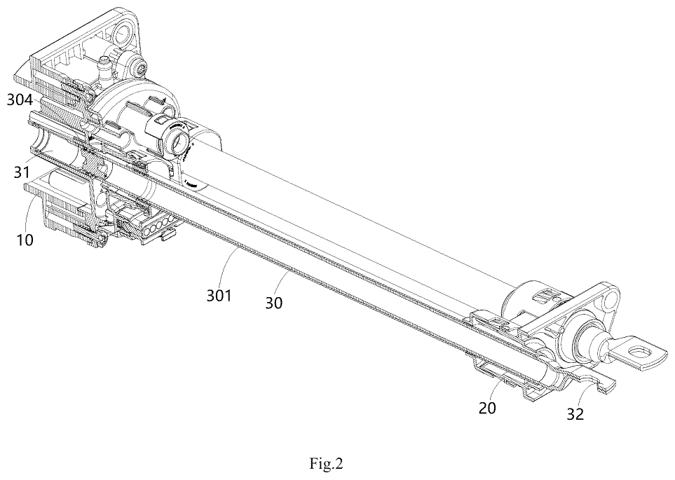

As shown in FIGS. 2 to 4, in the illustrated embodiments, the electrical connection assembly 3 further includes an insulation layer 301, which is formed on the outer surface of the electrical transmission body 33 of the electrical connection member 30. In an exemplary embodiment of the present invention, the insulation layer 301 on the electric transmission body 33 may be a heat shrink tube shrunk on the electric transmission body 33, an injection molded part molded on the electric transmission body 33, or a coating sprayed on the electric transmission body 33.

As shown in FIGS. 3 to 5, in the illustrated embodiments, a scaling ring installation groove 311 is formed on the outer surface of the mating end 31. The electrical connection assembly 3 also includes a sealing ring 304, shown in FIG. 2, which is installed in the scaling ring installation groove 311 to achieve sealing between the charging seat housing 10 and the mating end 31.

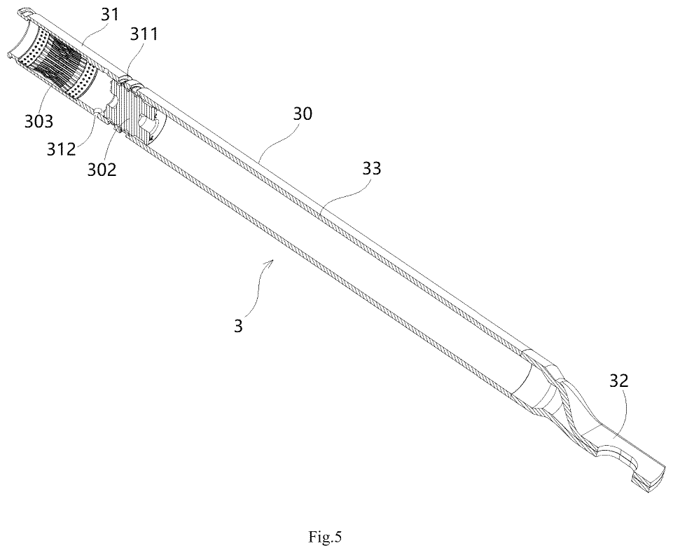

As shown in FIGS. 3 and 5, in the illustrated embodiments, a drainage hole 312 is formed on the mating end 31 that is communicated with the inner cavity of the mating end 31. The drainage hole 312 and the sealing ring installation groove 311 are spaced from each other in an axial direction of the mating end 31, and the drainage hole 312 is closer to the end face of the mating end 31 than the sealing ring installation groove 311. In this way, the water vapor entering the inner cavity of the mating end 31 can be discharged through the drainage hole 312.

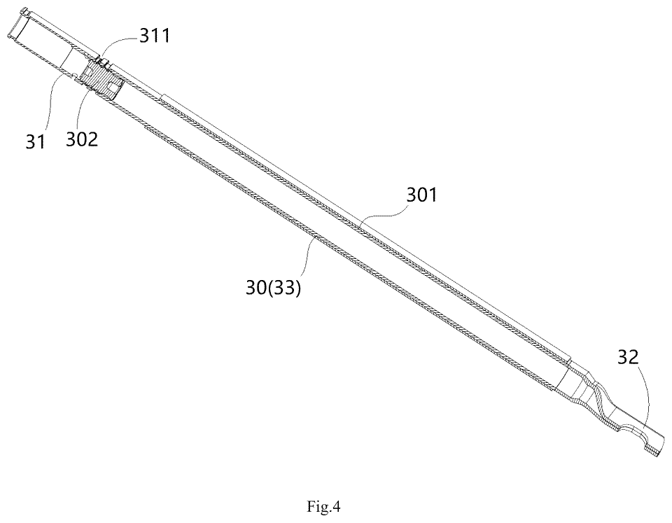

In the illustrated embodiments, the electric transmission body 33 of the electrical connection member 30 is in a hollow tubular shape. The electrical connection assembly 3 also includes a sealing plug 302, shown in FIG. 4, which is inserted into the inner cavity of the mating end 31 to prevent water vapor from entering the hollow electrical transmission body 33.

In another exemplary embodiment of the present invention, a charging seat assembly is also disclosed. The charging seat assembly includes the aforementioned electrical connection assembly 3 and the charging seat 1, as shown in FIG. 1. The charging seat 1 includes a charging seat housing 10. The mating end 31 of the electrical connection member 30 is inserted into the charging seat housing 10 to form a charging terminal of the charging seat 1 for mating and connecting with the mating terminal of the charging gun.

As shown in FIG. 1, in the illustrated embodiments, the charging seat assembly further comprises a connector 2. The connector 2 includes a connector housing 20. The connecting end 32 of the electrical connection member 30 is inserted into the connector housing 20 to form the connection terminal of the connector 2 for electrical connection with the busbar on the battery pack.

In the illustrated embodiments, the present invention does not require a separate charging terminal for charging seat 1 or a separate connection terminal for battery pack connector 2, which reduces production costs and improves manufacturing efficiency. In addition, the present invention can also reduce the resistance of the electrical connection product, which will reduce the temperature rise of the electrical connection product and improve the safety of the charging device.

In the illustrated embodiments, the integral electrical connection member 30 has lower cost, simpler manufacturing process, no crimping/welding processes, lower resistance, better performance, and greater stability. The integral electrical connection member 30 does not require crimping or welding, thus greatly reducing the internal space of the charging seat and connector, and greatly reducing the size of the charging seat and connector.

In the embodiments shown in FIGS. 1 to 8, the electrical connection member 30 forms an electrical connection between the charging seat 1 and a connector 2. However, the present invention is not limited to the illustrated embodiments, for example, the electrical connection member 30 of the present invention can also be used for electrical connection between two connectors. For example, in another exemplary embodiment of the present invention, there is also disclosed an electrical connection member 30, which includes: an electrical transmission body 33, a mating end 31 connected to one end of the electric transmission body 33, and a connecting end 32 connected to the other end of the electric transmission body 33. The electrical connection member 30 is an integral piece, the mating end 31 is used as a connecting terminal for one connector, and the connecting end 32 is used as a connecting terminal for another connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connection member, comprising:
an electric transmission body;
a mating end connected to a first end of the electric transmission body; and
a connecting end connected to a second end of the electric transmission body, the electrical connection member is an integral part, the mating end is a charging terminal for a charging seat and the connecting end is a connecting terminal for electrical connection with a busbar.

2. The electrical connection member of claim 1, wherein the mating end is cylindrical to mate and connect with a mating terminal in a charging gun.

3. The electrical connection member of claim 2, wherein the connecting end is flat or cylindrical.

4. The electrical connection member of claim 3, wherein the connecting end has a connection hole receiving a bolt that fastens the connecting end to the busbar.

5. The electrical connection member of claim 1, wherein the integral part is a hollow tubular piece, an end of the hollow tubular piece is processed into the mating end and another end of the hollow tubular piece is processed into the connecting end.

6. The electrical connection member of claim 5, wherein a middle part of the hollow tubular piece is the electric transmission body, the middle part has a hollow tubular shape.

7. The electrical connection member of claim 5, wherein a middle part of the hollow tubular piece is the electric transmission body, a portion of the middle part is flattened and bent and the electric transmission body has a flat bent portion.

8. The electrical connection member of claim 1, wherein the electrical connection member is an integral piece made of a solid rod-shaped component, an end of the solid rod-shaped component is processed into the mating end and another end of the solid rod-shaped component is processed into the connecting end.

9. The electrical connection member of claim 8, wherein the another end of the solid rod-shaped component is processed into a hollow cylindrical shape and then pressed into a flat shape.

10. An electrical connection assembly, comprising:
an electrical connection member including an electric transmission body, a mating end connected to a first end of the electric transmission body, and a connecting end connected to a second end of the electric transmission body, the electrical connection member is an integral part, the mating end is a charging terminal for a charging seat and the connecting end is a connecting terminal for electrical connection with a busbar; and
an elastic terminal inserted into an inner cavity of the mating end of the electrical connection member, the elastic terminal electrically contacts a mating terminal of a charging gun inserted into the mating end to electrically connect the mating terminal to the mating end.

11. The electrical connection assembly of claim 10, further comprising an insulation layer formed on an outer surface of the electrical transmission body of the electrical connection member.

12. The electrical connection assembly of claim 11, wherein the insulation layer is at least one of a heat shrinkable tube on the electric transmission body, an injection molded part on the electric transmission body, and a coating sprayed on the electric transmission body.

13. The electrical connection assembly of claim 10, wherein an outer peripheral surface of the mating end has a sealing ring installation groove.

14. The electrical connection assembly of claim 13, further comprising a sealing ring installed in the sealing ring installation groove to form a seal between a charging seat housing of the charging seat and the mating end.

15. The electrical connection assembly of claim 14, wherein the mating end has a hollow cylindrical shape, the mating end has a drainage hole communicating with the inner cavity of the mating end.

16. The electrical connection assembly of claim 15, wherein the drainage hole and the sealing ring installation groove are spaced from each other in an axial direction of the mating end, the drainage hole is closer to an end face of the mating end than the sealing ring installation groove.

17. The electrical connection assembly of claim 16, wherein the electric transmission body has a hollow tubular shape, a sealing plug is inserted into the inner cavity of the mating end.

18. A charging seat assembly, comprising:
an electrical connection assembly including:
an electrical connection member having an electric transmission body, a mating end connected to a first end of the electric transmission body, and a connecting end connected to a second end of the electric transmission body, the electrical connection member is an integral part; and
an elastic terminal inserted into an inner cavity of the mating end of the electrical connection member, the elastic terminal electrically contacts a mating terminal of a charging gun inserted into the mating end to electrically connect the mating terminal to the mating end; and
a charging seat including a charging seat housing, the mating end is inserted into the charging seat housing to form a charging terminal of the charging seat.

19. The charging seat assembly of claim 18, further comprising a connector including a connector housing, the connecting end of the electrical connection member is inserted into the connector housing to form a connection terminal of the connector for electrical connection with a busbar.

20. An electrical connection member, comprising:
an electric transmission body;
a mating end connected to a first end of the electric transmission body; and
a connecting end connected to a second end of the electric transmission body, the electrical connection member is an integral part, the mating end is a connecting terminal for a connector and the connecting end is a connecting terminal for another connector.
